(19) United States
(12) Patent Application Publication
(10) Pub. No.: US 2025/0183343 A1
(43) Pub. Date: Jun. 5, 2025

(54) DEVICES AND METHODS FOR SIMULTANEOUS MECHANOCHEMICAL AND ELECTROCHEMICAL REACTIONS

(71) Applicant: University of Cincinnati, Cincinnati, OH (US)

(72) Inventors: Mennatullah Mokhtar, Cincinnati, OH (US); James Mack, II, Cincinnati, OH (US)

(73) Assignee: University of Cincinnati, Cincinnati, OH (US)

(21) Appl. No.: 18/969,088

(22) Filed: Dec. 4, 2024

Related U.S. Application Data
(60) Provisional application No. 63/605,726, filed on Dec. 4, 2023.

(51) Int. Cl. H01M 8/18; H01M 4/86

(52) U.S. Cl. CPC H01M 8/188; H01M 4/86

(57) ABSTRACT

The present invention is directed to a method and apparatus for simultaneously implementing mechanochemical and electrochemical synthesis conditions. With respect to the method, the method may be configured to improve one or more reaction metric such as increasing product yield, reducing organic solvent consumption, reducing the reaction time, reducing the amount of, or completely eliminating, at least one toxic reagent or solvent, or enabling electrochemical synthesis of the chemical product without complete solubility of the organic substrate in the organic solvent. With respect to the apparatus, the apparatus is configured to define a reaction area between an anode and cathode that can be mechanochemically agitated to improve synthesis without disrupting the electrochemical reaction.

### STATEMENT REGARDING FEDERALLY FUNDED RESEARCH OR DEVELOPMENT

This invention was made with government support under CHE-1900097 awarded by the National Science Foundation. The government has certain rights in the invention.

### TECHNICAL FIELD

The present invention relates to the simultaneous application of mechanochemical principles and electrochemical principles, specifically apparatuses and methods for inducing mechanoelectrochemical reactions.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Traditionally, electrochemical setups employed in both academic and industrial settings have utilized glass vessels with electrodes immersed within. Electrochemical cells are useful in promoting reactions in so far as potential of electrodes can be tuned to drive oxidation-reduction reactions with controlled selectivity for reagents of interest that would not occur at the same rates or yields otherwise. However, this approach becomes problematic and unsafe when applied under milling conditions, as the inherent fragility of glassware leads to breakages and renders it unsuitable for mechanical processes. Moreover, electrochemical reactions typically involve dissolving the reagents in conductive media, which can be limiting on reactions that can be performed while also creating significant amounts of solvent waste that is costly to dispose of correctly.

Conversely, standard mechanochemical setups can reduce the impact of the negative consequences of traditional solution-based reactions. For example, mechanochemical reactions can significantly reduce or eliminate the need for solvent, which would otherwise result in environmentally damaging waste. Moreover, mechanochemical reactions facilitate or enable reactions by applying kinetic energy to a mixture of reagents, enabling reactions to occur at lower temperatures or even with less catalysts. Mechanochemical processes can also exhibit unique reaction selectivity and reactivity not observed in traditional methods, enabling the synthesis of novel products and processes that may be unattainable through conventional solution-based approaches. However, standard mechanochemical setups consist of a single metal vessel, which lacks the necessary configuration for conducting electrochemical reactions. Such reactions necessitate a minimum of two separate, non-touching conductive electrodes to enable a potential difference between the two electrodes. Accordingly, there is a need for a device and method of simultaneously implementing mechanochemical reactions and electrochemical reactions.

### BRIEF DESCRIPTION OF THE DRAWINGS

The objects and advantages of the disclosed invention will be further appreciated in light of the following detailed descriptions and drawings in which:

FIG. 1 is a cross-sectional view of an embodiment of the present invention showing the first portion and the second portion disconnected.

FIG. 2 is a cross-sectional view of the embodiment of FIG. 1 showing the first portion and the second portion connected.

FIG. 3 is an exploded view of the embodiment of FIG. 1.

FIG. 4 is a cross-sectional view of another embodiment of the present invention.

FIG. 5 is a cross-sectional view of another embodiment of the present invention.

FIG. 6 is a cross-sectional view of another embodiment of the present invention.

FIG. 7 is a cross-sectional view of another embodiment of the present invention.

FIG. 8 is a cross-sectional view of another embodiment of the present invention.

FIG. 9 is a cross-sectional view of another embodiment of the present invention.

FIG. 10 is a cross-sectional view of another embodiment of the present invention.

FIG. 11 is a perspective view of the embodiment of FIG. 1 contained within an agitating device in accordance with an embodiment of the invention.

### SUMMARY

A first aspect of this invention is directed to a method of synthesizing a chemical product from a substrate and a solvent using a redox reaction, the method comprising: (a) applying mechanochemical activation to the substrate and the solvent, wherein mechanochemical activation does not involve stirring; and (b) simultaneously applying an electric current or an electric potential in an amount sufficient to simultaneously induce an electrochemically mediated reaction of the substrate. In an embodiment of the first aspect of the invention, the simultaneous application of the electric current or the electric potential and mechanochemical activation improves at least one reaction metric, relative to an otherwise identical reaction not including either step (a) or step (b), selected from the list consisting of: increasing product yield; reducing solvent consumption; reducing the reaction time; reducing the amount of at least one toxic reagent or solvent; completely eliminating at least one toxic reagent or solvent; and enabling electrochemical synthesis of the chemical product without complete solubility of the substrate in the solvent. In one such embodiment, the improved reaction metric comprises improving product yield, and wherein improved product yield is measured as an increase in the percent conversion of the substrate into the chemical product. In another such embodiment, the improved reaction metric comprises reducing solvent consumption as measured by a reduction in process mass intensity (PMI) relative to at least one of an otherwise equivalent electrochemical cell batch process and an otherwise equivalent microflow electro-cell process. In another such embodiment, the improved reaction metric comprises a reduced reaction time. In another such embodiment, the improved reaction metric comprises reducing the amount of at least one toxic reagent or solvent. In another such embodiment, the improved reaction metric comprises eliminating at least one toxic reagent or solvent. The method of claim 2, wherein the improved reaction metric comprises enabling electrochemical synthesis of the chemical product without complete solubility of the substrate in the solvent.

In another embodiment of the first aspect of the invention, the mechanochemical agitation comprises mechanochemical milling. In a further embodiment thereof, the mechanochemical mixing comprises either mixer milling or ball milling.

In another embodiment of the first aspect of the invention, the redox reaction occurs within a reaction area having a volume, wherein the solvent is included at a volume that is less than or equal to 30% of the reaction area volume, and wherein the mechanochemical agitation improves contact of the substrate with an anode and a cathode used to apply the electric current or the electric potential. Alternatively, the solvent may be included at a volume less than or equal to 50%, alternatively less than or equal to 40%, alternatively less than or equal to 20%, alternatively less than or equal to 10%, alternatively less than or equal to 5%, or alternatively less than or equal to 1%.

In another embodiment of the first aspect of the invention, the mechanochemical agitation occurs at a frequency at or below 30 Hz. Alternatively, the mechanochemical agitation may occur at a frequency less than or equal to 25 Hz, alternatively less than or equal to 20 Hz, alternatively less than or equal to 15 Hz, alternatively less than or equal to 10 Hz, or alternatively less than or equal to 5 Hz.

In another embodiment of the first aspect of the invention, the ratio of the solvent to the substrate is less than or equal to 50 μL/mg. Alternatively, the ratio may be less than or equal to 40 μL/mg, alternatively less than or equal to 30 μL/mg, alternatively less than or equal to 20 μL/mg, alternatively less than or equal to 12.5 μL/mg, alternatively less than or equal to 10 μL/mg, alternatively less than or equal to 6.25 μL/mg, or alternatively less than or equal to 5 μL/mg.

A second aspect of the invention is directed to a mechanoelectrochemical cell configured to simultaneously subject at least one reagent to simultaneous mechanochemical and electrochemical reactions, the mechanoelectrochemical cell comprising: a first portion having a first outer shell comprising an electrically inert material and a first electrode positioned within the first outer shell; a second portion having a second outer shell, wherein the second outer shell is configured to function as a second electrode; wherein the first portion and the second portion are connected to form a sealed reaction area between the first electrode and second electrode. In an embodiment of this second aspect of the invention, the second portion comprises a modular portion configured to receive a modular component selected from the list consisting of a vent, a third electrode, and a window. In another embodiment of the second aspect of the invention, the second portion further comprises a vent.

A third aspect of the invention is directed to a mechanoelectrochemical cell configured to simultaneously subject at least one reagent to simultaneous mechanochemical and electrochemical reactions, the mechanoelectrochemical cell comprising: a first portion having a first outer shell and a first electrode; a second portion having a second outer shell and a second electrode; and a third portion, wherein the third portion is configured to connect with the first outer shell on a first end and the second outer shell on a second end to form a sealed reaction area, and wherein the points of connection between the third portion and both the first and second portion remain electrically insulated. In an embodiment of the third aspect of the invention, the first outer shell functions as the first electrode and the second outer shell functions as a second electrode. In another embodiment of the third aspect of the invention, the first electrode is a first conductive piece positioned at a distal end of the first outer shell and the second electrode is a second conductive piece positioned at a distal end of the second outer shell. In a further embodiment thereof, the first conductive piece is a foil. In a different further embodiment thereof, the second conductive piece is a foil. In yet another different embodiment, both the first conductive piece and the second conductive piece are foils, wherein the foils comprise different metals.

### Definitions

As used herein, the term “about,” when referring to a value or to an amount of mass, weight, time, volume, pH, size, concentration or percentage is meant to encompass variations of ±20% in some embodiments, ±10% in some embodiments, ±5% in some embodiments, ±1% in some embodiments, ±0.5% in some embodiments, and ±0.1% in some embodiments from the specified amount, as such variations are appropriate to perform the disclosed method.

As used herein, the term “η” refers to the ratio between a solvent to a reagent, such as an organic substrate. Unless otherwise stated, the units for η are μL/mg.

As used herein, the term “slurry” shall mean that the solids, such as a chemical reagent, are suspended in a solvent without significant dissolution (i.e., less than about 50% dissolved).

As used herein, the term “mechanochemical activation” means to induce or aid a chemical reaction via the absorption of mechanical energy.

As used herein, the term “reagent” or “reagents” refers to a substrate used in a reaction outlined herein, both a substrate and solvent used in a reaction as outlined herein, or to a substrate, solvent, and other reactants in a reaction as outlined herein.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. For example, despite showing that embodiments of the invention may have rounded shapes or tubular shapes, it should be understood that aspects like the shape of the embodiment may differ without deviating from the scope of this invention. Moreover, it should be appreciated that such a development effort might be complex and time consuming, but would nevertheless be a routine undertaking of design, fabrication, and manufacture for those of ordinary skill having the benefit of this disclosure.

The present invention represents a significant tool in the integration of two distinct fields, namely mechanochemistry y and electrochemistry, resulting in the emergence of mechanoelectrochemistry. This novel field presents a set of formidable challenges, chief among them being the development of an electrochemical cell capable of conducting current sufficient to enable electrochemistry under mechanochemical conditions. In aspects of the present invention, these challenges are overcome by introducing a mechanoelectrochemical cell design featuring two electrodes. These pioneering designs have two portions containing an electrode that can be securely connected (e.g., clamped within an agitating device) and connected to external power sources via terminals, enabling the execution of electrochemical reactions within a mechanistic framework, all while minimizing solvent utilization.

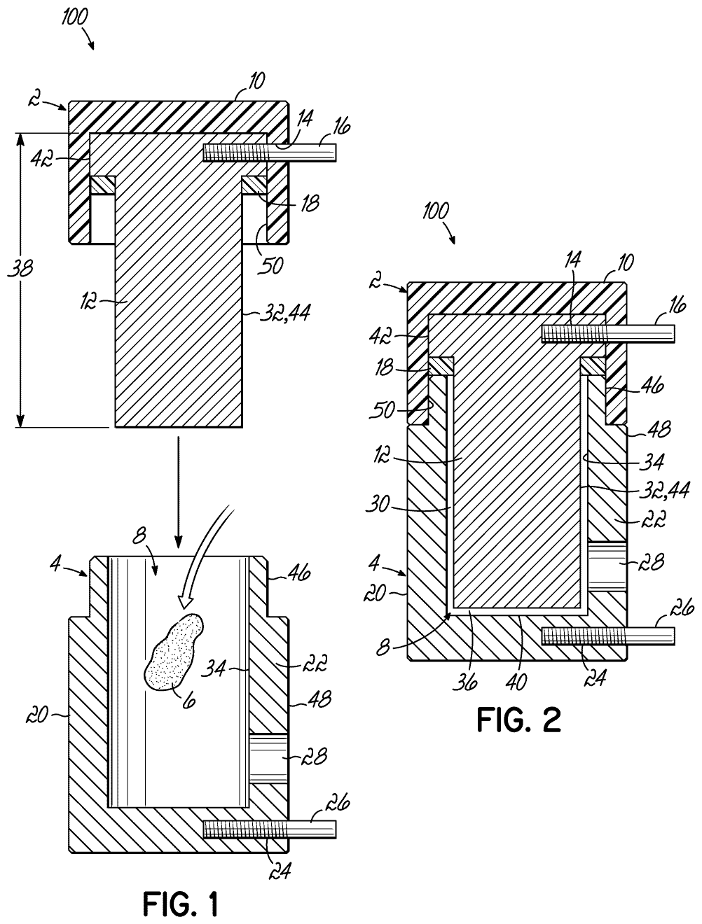

With respect to FIGS. 1-3, an embodiment of the mechanoelectrochemical chemical cell 100 is shown. In this embodiment, the mechanoelectrochemical chemical cell 100 comprises a first portion 2 and a second portion 4. As shown in FIG. 1, these first and second portions 2 and 4 can be disconnected so that reagents 6 may be inserted into the reaction area 8. The mechanoelectrochemical processes that takes place in the reaction area 8 will be discussed further below.

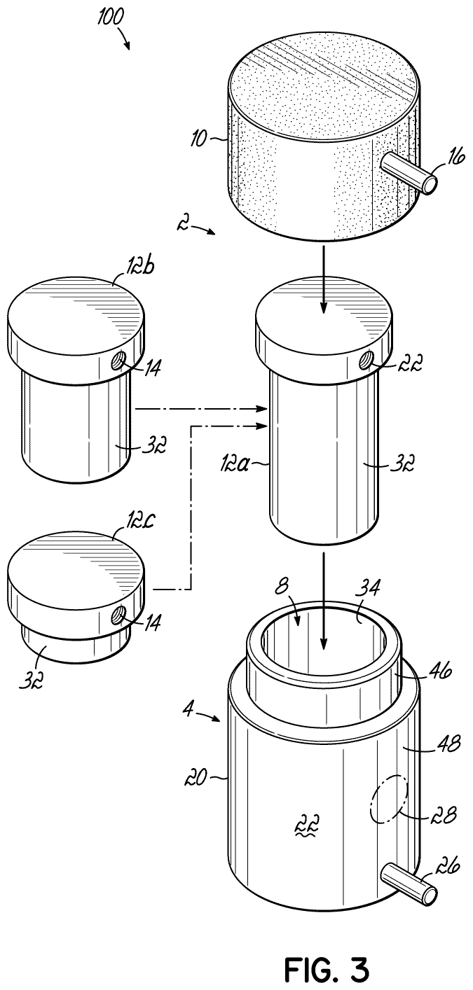

With further respect to the mechanoelectrochemical cell 100 shown in FIGS. 1-3, as indicated using the crosshatching, the first portion 2 of the mechanoelectrochemical cell 100 comprises an first outer shell 10, which includes an inert material (discussed further below), and a first conductive material 12, wherein the first conductive material is positioned within the first outer shell 10, and wherein the first outer shell 10 and the first conductive material 12 each has a first electrode connector receptacle 14 (see FIG. 3) configured to receive a first electrode connector 16 through the walls of both the first outer shell 10 and the first conductive material 12. Although not shown in FIGS. 1-3, the first electrode connector 16 is configured to be connected to one of a cathode or anode, specifically the opposite of the second electrode connector 26 (discussed further below), and includes a material that can conduct electricity (discussed further below). In the embodiment of the mechanoelectrochemical cell 100, the first outer shell 10 is an inert material (discussed further below). The first portion 2 also is configured to contain, have, or come into contact with a separation element 18 (discussed further below). The second portion 4 comprises a second outer shell 20 and a second conductive material 22, which in the embodiment of the mechanoelectrochemical cell 100 is the second outer shell 20. Similar to the first portion 2, the second portion 4 also has a second electrode connector receptacle 24 which is configured to receive a second electrode connector 26 through the wall. Although not shown in FIGS. 1-3, the second electrode connector 26 is configured to be connected to one of an anode or cathode, specifically the opposite of the first electrode connector 16, and includes a material that can conduct electricity (discussed further below). The second portion also has or contains a modular portion 28 (discussed further below).

With further respect to the first outer shell 10, the first outer shell 10 comprises an inert material. As shown, the entirety of the first outer shell 10 is an inert material. However, alternate embodiments wherein there is only an inert material layer at the surfaces of the first outer shell 10 that come in contact with the second outer shell 20 during operation (not shown). The inert material may be any sufficiently non-conductive material including but not limited to plastics (e.g., polyvinyl, polyvinyl chloride (PVC), polycarbonate (PC), poly(methyl methacrylate) (PMMA), polyethylene (PE), polypropylene (PP), polyethylene terephthalate (PET), polytetrafluoroethylene (PTFE, also known as Teflon), polyoxymethylene (POM, also known as Delrin) etc.), rubbers, silicone, glass, ceramics (e.g., silicon carbide, silicon nitride, tungsten carbide, aluminum nitride, aluminum oxide, beryllium oxide, magnesium oxide, boron nitride, zirconia, titanium dioxide, chromium oxide, etc.), another suitable non-conductive material, or a combination thereof.

With further respect to the first conductive material 12, this may comprise a conductive material selected from the list consisting of a metal (e.g., copper, iron, aluminum, tin, chromium, titanium, silver, platinum, nickel, magnesium, gold, other suitably conductive metals), an alloy (e.g., stainless steel, carbon steel, brass, bronze, other suitable alloys of the metals above), a semiconductor (e.g., silica, n-doped silica, p-doped silica, graphite, graphene, germanium, gallium arsenide, cadmium telluride, zinc oxide, other commonly semiconductive materials), some other suitable conductive material, or a combination thereof. With respect to the outer conductive material 22, this may comprise a second conductive material (i.e., not the same as the first conductive material 12) selected from the list consisting of a metal (e.g., copper, iron, aluminum, tin, chromium, titanium, silver, platinum, nickel, magnesium, gold, other suitably conductive metals), an alloy (e.g., stainless steel, carbon steel, brass, bronze, other suitable alloys of the metals above), a semiconductor (e.g., silica, n-doped silica, p-doped silica, graphite, graphene, germanium, gallium arsenide, cadmium telluride, zinc oxide, other commonly semiconductive materials), some other suitable conductive material, or a combination thereof.

With further respect to the first electrode connector 16 and second electrode connector 26, these components are configured to allow for the flow of electrons from a power source (not shown) to the mechanoelectrochemical cell 100. As shown, the electrode connectors 16, 26 help stabilize the electrical circuit and reduce the risk of short circuits or overheating. Additionally, these electrode connectors 16, 26 provide secure and reliable physical connections, ensuring continuous contact even under varying electrical loads. These electrode connectors 16, 26 also are versatile and adaptable, making it easier to link power sources to different components within the mechanoelectrochemical cell 100. With further respect to the first electrode connector 16, this is configured to be connected to the power source and allow for the flow of electrons between the first conductive material 12 and the power source such that the first conductive material 12 acts as the cathode or anode. Similarly, the second electrode connector 26 is configured to allow for the flow of electrons between the power source and the second conductive material 22 such that the second conductive material acts as the anode or cathode (opposite of the first electrode connector 16). Accordingly, the first electrode connector 16 and second electrode connector 26 comprise a conductive material. In some such embodiments, that conductive material may be selected from the list consisting of a metal (e.g., copper, iron, aluminum, tin, chromium, titanium, silver, platinum, nickel, magnesium, gold, other suitably conductive metals), an alloy (e.g., stainless steel, carbon steel, brass, bronze, other suitable alloys of the metals above), a semiconductor (e.g., silica, n-doped silica, p-doped silica, graphite, graphene, germanium, gallium arsenide, cadmium telluride, zinc oxide, other commonly semiconductive materials), some other suitable conductive material, or a combination thereof.

With further respect to the first electrode connector 16 as shown in FIGS. 1-3, the first electrode connector is further configured to function as a means for connecting with the first conductive material 12 to retain the first conductive material 12 in position relative to the first outer shell 10. In such embodiments, the first electrode connector 16 may be threaded as shown in the mechanoelectrochemical cell 100. However, in other embodiments, alternative means for connecting the first electrode connector 16 and the first conductive material 12 may be used including, but not limited to, welding, soldering, rivets, magnets, adhesives, pins and dowels, other suitable means for connecting two pieces together, or some combination thereof.

With further respect to the general principles of the mechanoelectrochemical cell 100, it is relevant that the first outer shell 10 comprises an inert material and the second outer shell is a conductive material. If both materials were conductive, the electrodes would be in contact when the first portion 2 and the second portion 4 are connected during operation of the mechanoelectrochemical cell 100, which would be undesirable as it would create difficulties in maintaining a potential difference between the electrodes. Accordingly, the first portion 2 has a first conductive material 12 positioned in the interior of the outer shell 10 while the second portion 4 has a second outer shell 20 that is the second conductive material 22, the space between which defines the reaction area 8 which can receive the reagents 6.

In the mechanoelectrochemical cell 100, the reaction area 8 defines a wall space 30, which is defined as the space between a first conductive material outer perimeter 32 and a second outer conductive material inner perimeter 34. As discussed herein for the mechanoelectrochemical cell 100, the first conductive material outer perimeter 32 refers to the smaller perimeter on the bottom of the first conductive material 12 (further discussion of the different diameters below). This wall space 30 may be modified by adjusting the first conductive material outer perimeter 32 (not shown) and the second outer conductive material inner perimeter 34 (not shown). This wall space 30 can be expressed as a percentage of the first conductive material outer perimeter 32 relative to the total perimeter defined by the second outer conductive material inner perimeter 34, wherein the materials would be in contact at 0% wall space 30 and no first conductive material 12 would be included at 100% wall space 30. Accordingly, in some embodiments, the wall space 30 may be defined as a minimum percentage, such as greater than or equal to 1%, alternatively greater than or equal to 5%, alternatively greater than or equal to 10%, alternatively greater than or equal to 25%, alternatively greater than or equal to 50%, alternatively greater than or equal to 75%, alternatively greater than or equal to 90%, alternatively greater than or equal to 95%, or alternatively greater than or equal to 99%. Alternatively, in other embodiments, the wall space 30 may be defined as a maximum percentage, such as less than or equal to 99%, alternatively less than or equal to 95%, alternatively less than or equal to 90%, alternatively less than or equal to 75%, alternatively less than or equal to 50%, alternatively less than or equal to 25%, alternatively less than or equal to 10%, alternatively less than or equal to 5%, or alternatively less than or equal to 1%. Without being bound by theory, it is believed that minimizing the wall space is desirable because it increases electrode contact with the reagents without having to increase the amount of solvent. However, as more reagent 6 and/or solvent is added to fill the wall space 30, minimization of wall space 30 has less of an effect on increasing electrode contact, especially when used in a horizontal orientation as shown in FIGS. 5-7. In yet other alternate embodiments, the wall space 30 may be defined as a range of percentages, such as greater than or equal to 1% and less than or equal to 5%, alternatively greater than or equal to 1% and less than or equal to 10%, alternatively greater than or equal to 1% and less than or equal to 25%, alternatively greater than or equal to 1% and less than or equal to 50%, alternatively greater than or equal to 1% and less than or equal to 75%, alternatively greater than or equal to 1% and less than or equal to 90%, alternatively greater than or equal to 1% and less than or equal to 95%, or alternatively greater than or equal to 1% and less than or equal to 99%.

Additionally, the reaction area 8 also defines a floor space 36, which is defined as the space below the lowest point of the first conductive material 12 and above the highest inner point of the second conductive material 22. This floor space may be modified by adjusting one or more of a first conductive material height 38 (see FIG. 3, first conductive material 12A, 12B, 12C) and/or the second outer conductive material bottom edge 40 (not shown). This floor space 36 can be expressed as a percentage of the first conductive material outer height 38 relative to the total vertical space defined by the second outer conductive material bottom edge 40, wherein the materials would be in contact at 0% floor space 36 and no first conductive material 12 would be included at 100% floor space 36. Accordingly, in some embodiments, the floor space 36 may be defined as a minimum percentage, such as greater than or equal to 1%, alternatively greater than or equal to 5%, alternatively greater than or equal to 10%, alternatively greater than or equal to 25%, alternatively greater than or equal to 50%, alternatively greater than or equal to 75%, alternatively greater than or equal to 90%, alternatively greater than or equal to 95%, or alternatively greater than or equal to 99%. Alternatively, in other embodiments, the floor space 36 may be defined as a maximum percentage, such as less than or equal to 99%, alternatively less than or equal to 95%, alternatively less than or equal to 90%, alternatively less than or equal to 75%, alternatively less than or equal to 50%, alternatively less than or equal to 25%, alternatively less than or equal to 10%, alternatively less than or equal to 5%, or alternatively less than or equal to 1%. Without being bound by theory, it is believed that minimizing the floor space is desirable because it increases electrode contact with the reagents without having to increase the amount of solvent. However, as more reagent 6 and/or solvent is added to fill the floor space 36, minimization of floor space 36 has less of an effect on increasing electrode contact when used in a vertical orientation as shown in FIGS. 1-3. In yet other alternate embodiments, the floor space 36 may be defined as a range of percentages, such as greater than or equal to 1% and less than or equal to 5%, alternatively greater than or equal to 1% and less than or equal to 10%, alternatively greater than or equal to 1% and less than or equal to 25%, alternatively greater than or equal to 1% and less than or equal to 50%, alternatively greater than or equal to 1% and less than or equal to 75%, alternatively greater than or equal to 1% and less than or equal to 90%, alternatively greater than or equal to 1% and less than or equal to 95%, or alternatively greater than or equal to 1% and less than or equal to 99%.

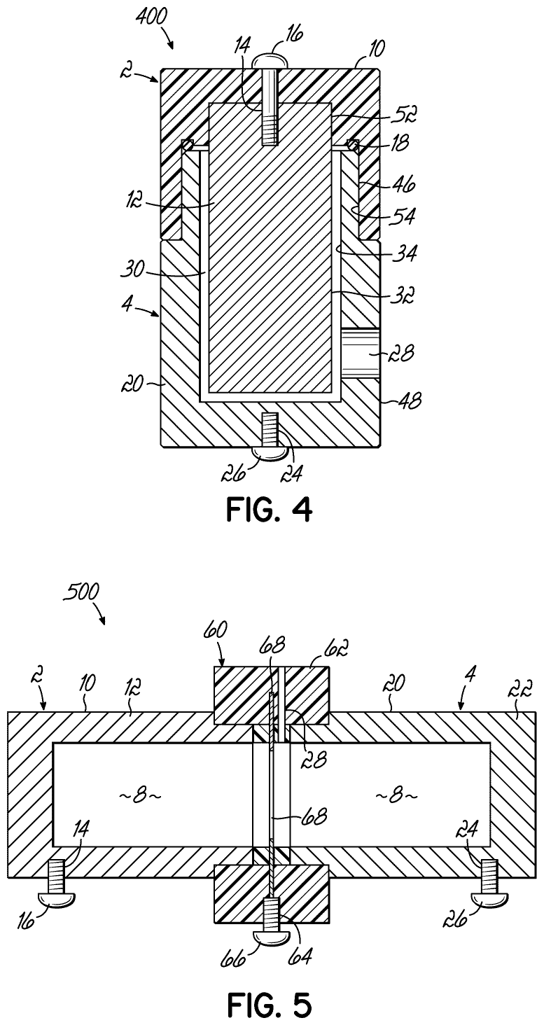

With further respect to the separation element 18 as shown in FIGS. 1-2, the separation element 18 comprises an inert material inserted between the first portion 2 and the second portion 4 configured to prevent contact between their respective conductive materials 12, 22. In some embodiments, the separation element 18 can also help hold the conductive material 12 in place. In the shown embodiment, the separation element 18 is an o-ring or other suitably inert material (e.g., a plastic or other inert materials discussed above). In other embodiments, the separation element 18 can be made using a conductive material (such as those outlined above) provided that the mechanoelectrochemical cell 100 would not bring the anode and cathode into contact otherwise. Specifically, the shown embodiment comprises a first conductive material 12 having two perimeters, specifically a first conductive material upper perimeter 42 coextensive with a first outer shell inner perimeter 50 and a first conductive material lower perimeter 44 for the lower portion that extends into the second outer shell 20, previously identified above as the first conductive material outer perimeter 32 in this embodiment. As seen in FIGS. 1-3, the first conductive material lower perimeter 44 has a perimeter less than the first conductive material upper perimeter 42. These dimensions have counterparts with the second outer shell 20, which further comprises an upper portion (which may be referred to as an second portion upper flange) having a second outer shell upper outer perimeter 46 and a lower portion (which may be referred to as the second portion body) having a second outer shell lower outer perimeter 48 which is greater than the second outer shell upper outer perimeter 46. In one embodiment, the first conductive material upper perimeter 42 is about equal to or equal to the second outer shell upper outer perimeter 46. In a further such embodiment, the separation element 18 has about the same or the same outer dimensions. In an even further embodiment thereof, the separation element 18 extends further into the interior so that the inner dimension is almost in contact with, or alternatively is in contact with, the first conductive material lower perimeter 44. Alternatively, the first conductive material 12 might have a single diameter, specifically the first conductive material outer perimeter 32 and/or first conductive material lower perimeter 44 (not shown in FIGS. 1-3, see FIG. 4 for reference and for further discussion below).

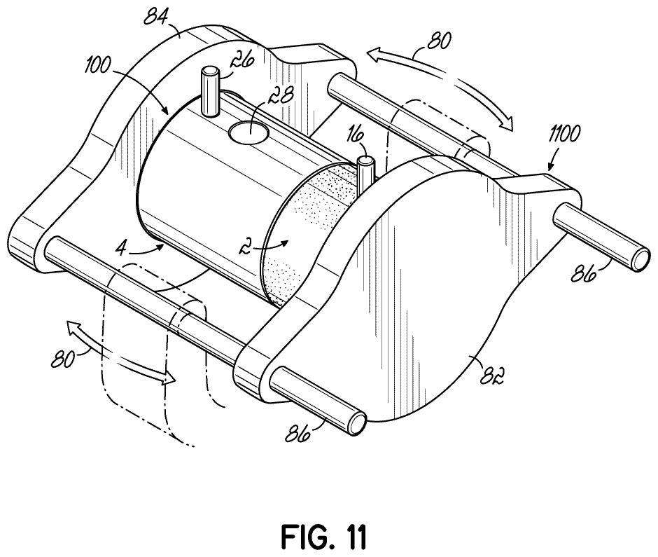

In the embodiments shown, the first portion 2 and second portion 4 of the mechanoelectrochemical cell 100 are configured to be connected by applying force at opposite ends (i.e., clamping, see FIG. 11). Although not shown in FIGS. 1-4, the first portion 2 and second portion 4 may be connected using commonly employed means for connecting two mechanical portions at the connection point between the two portions such as, for example, adhesives, screw threading, or any other suitable means for connecting two pieces known in the art.

With further respect to the modular portion 28, this is configured to function as a slot, in fluid communication with the reaction area 8, into which a functional piece may be inserted to achieve a desired effect. In one embodiment, the modular portion 28 receives a plug configured to seal the reaction area 8. In another embodiment, the modular portion 28 receives a vent that is configured to allow for pressure built up within the reaction area 8 to be released. In a further embodiment, the vent may be configured to allow access into the mechanoelectrochemical cell 100, functioning as a sampling port that allows for real-time analysis of reaction progress. In yet another embodiment, the modular portion receives a window configured to allow visibility within the reaction area 8. In still another embodiment, the modular portion 28 receives a third electrode connector configured to be connected to an electrode selected from the list consisting of a reference electrode, a quasi-reference electrode, or some other auxiliary electrode.

With reference to the embodiment of FIG. 4, the description above of FIGS. 1-3 applies except for where differences are explicitly noted. Generally speaking, these embodiments are substantially the same, with two major differences. First, the placement of the electrode connector receptacles 14, 24 and the corresponding placement of the electrode connectors 16, 26 is different. Instead of going through the sidewalls of the first and second portions 2, 4, the electrode connector receptacles 14, 24 and corresponding electrode connectors 16, 26 are positioned on the top (first portion 2) and bottom (second portion 4) instead.

Second, the inner shape of the first outer shell 10 is changed to accommodate a first conductive material with a more uniform perimeter. Accordingly, instead of the first conductive material 12 having the first conductive material upper perimeter 42 and lower perimeter 44 like in FIGS. 1-3, the first conductive material has a single first conductive material outer perimeter 32. To accommodate this change, the first outer shell 10 has a different shape wherein there are two inner perimeters instead of a single perimeter 50, specifically a first outer shell upper inner perimeter 52 having a smaller perimeter and a first outer shell lower inner perimeter 54 having a larger perimeter. As shown, the first outer shell upper inner perimeter 52 is coextensive with the first conductive material outer perimeter 32, such that there is nearly no gap, alternatively substantively no gap, or alternatively no gap between the first outer shell 10 and the first conductive material 12. Furthermore, the bottom most portion of the first outer shell defining the upper inner perimeter 52 may be referred to as a first portion upper flange, which rests on top of the second portion upper flange as shown. Accordingly, because the first outer shell comprises an inert material as described above, the separation element 18 is optional in this embodiment because it is not necessary to ensure separation of the electrodes in operation.

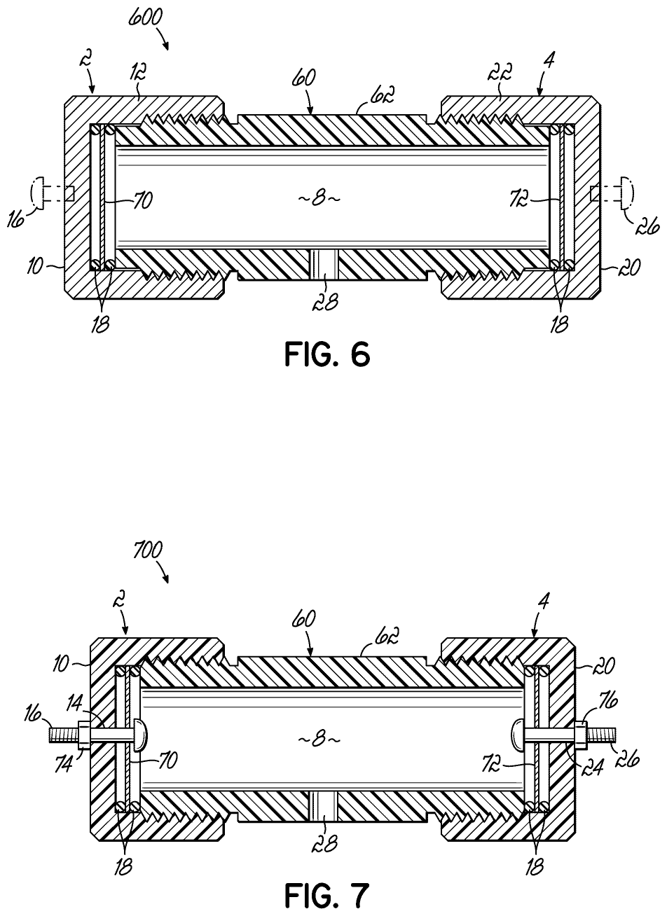

With reference now to FIGS. 5-7, another aspect of the invention is shown through the mechanoelectrochemical cells 500, 600, and 700. Unlike in the above embodiments of FIGS. 1-4 above wherein the first conductive material 12 is contained within the interior of the outer shell 10 and extends towards the second portion 4, the embodiments of FIGS. 5-6 have a first portion 2 wherein the first outer shell 10 is the first conductive material 12 and a second portion 4 wherein second outer shell 20 is the second conductive material 22. Accordingly, to ensure that the two conductive materials are not in contact with each other a third portion 60 is included between and in contact with both the first outer shell 10 and the second outer shell 20. As shown, the third portion 60 has a substantially tubular shape that is configured to connect with the open ends of each of the outer shells 10, 20. However, it is known that the shape of the third portion 60 may vary based on the shape of the corresponding first portion 2 and the second portion 4. For example, in embodiments wherein the first portion 2 has a rectangular prism shape, at least the area of the third portion 60 configured to connect with the first portion 2 will also have a rectangular prism shape, or alternatively the entirety of the third portion may be shaped like a rectangular prism (not shown). As shown, this third portion 60 comprises a third material 62. In one embodiment, the third material 62 is a non-conductive or insulating material such as any insulating material previously identified. Alternatively, the third portion 60 may have a non-conductive material layered or coated onto surfaces of the third material 62 that may come in contact with the reagents 6 (not shown) or with any conductive portions of the first portion 2 and/or the second portion 4. In either case, the third material 62 may be or include a material selected from the list consisting of plastics (e.g., polyvinyl, PVC, PC, PMMA, PE, PP, PET, PTFE, etc.), rubbers, silicone, glass, ceramics (e.g., silicon carbide, silicon nitride, tungsten carbide, aluminum nitride, aluminum oxide, beryllium oxide, magnesium oxide, boron nitride, zirconia, titanium dioxide, chromium oxide, etc.), another suitable non-conductive material, or a combination thereof. In other embodiments not shown here, the third material 62 may instead comprise a conductive material, including any previously identified conductive material (not shown), provided that the connection between the third portion 60 and the first conductive material 12 is electrically insulated and the connection between the third portion 60 and the second conductive material 22 is electrically insulated. In such embodiments, the connection may be insulated by providing a non-conductive material layer between the connection of the third portion 60 and both other conductive materials 12, 22 such as by, for example, coating an electrically insulating layer onto the area of the third portion 60 in contact with the other conductive materials 12, 22, coating an electrically insulating layer onto any areas of conductive materials 12, 22 in contact with the third portion 60, or providing a separate component made of an insulating material (e.g., an o-ring) between the third portion 60 and the any portions of conductive materials 12, 22 that would otherwise be in contact with the third portion 60 and position this insulating material in between the third portion 60 and the conductive materials 12, 22. Alternatively, it may not be necessary to incorporate an insulating material between the third portion 60 and the other conductive materials 12, 22 if the point of connection are not both electrically conductive materials.

With reference now to FIGS. 5, the third portion 60 may optionally be configured to house a third electrode. To that end, as shown in FIG. 5, the third material 62 may include an third electrode connector receptacle 64 which is configured to receive a third electrode connector 66 and enable the flow of electrons between a power source (not shown) and an inner conductive material ring 68. As shown, the entirety of the third material 62 is a insulating material or a non-conductive material. However, in other embodiments not shown here, the third material 62 may instead be a conductive material if two conditions are met. First, the point of connection between the third material 62 and both the first and second materials 12, 22 must be separated by an insulating material such as, for example, an insulating material at the point of connection that may be a layer or another material (e.g., an o-ring). Second, the point of connection between the third material 62 and the inner conductive material ring 68 (discussed further below) must also be separated by an insulating material. In essence, so long as the third material 62 is not able to permit the flow of electrons between itself and other adjacent conductive materials, the third material 62 may itself be a conductive material. As shown, a portion of the inner conductive material ring 68 is exposed to the reaction area 8 without being in contact with any other conductive materials connected to electrodes as shown in FIG. 5. In one embodiment, the third electrode connector 66 and the inner conductive material ring 68 function as a reference electrode. Alternatively, the third electrode may function as an auxiliary electrode (e.g., a counter electrode) or a quasi-reference electrode. The third electrode connector 66 and/or inner conductive material ring 68 conductive material may be selected from the list consisting of a metal (e.g., copper, iron, aluminum, tin, chromium, titanium, silver, platinum, nickel, magnesium, gold, other suitably conductive metals), an alloy (e.g., stainless steel, carbon steel, brass, bronze, other suitable alloys of the metals above), a semiconductor (e.g., silica, n-doped silica, p-doped silica, graphite, graphene, germanium, gallium arsenide, cadmium telluride, zinc oxide, other commonly semiconductive materials), some other suitable conductive material, or a combination thereof. Although these components 64, 66, 68 are not shown in the embodiments of FIGS. 6 and 7, a similar set up may be used in those embodiments as well.

With further respect to FIGS. 6 and 7, the same aspects from FIG. 5 apply with one key modification. Specifically, a third conductive material piece 70 and a second conductive material piece 72 are included in the first outer shell 10 and second outer shell 20 respectively. As shown, these conductive material pieces 70, 72 are positioned adjacent or near to the distal ends of the interiors of the first outer shell 10 and second outer shell 20, sandwiched between two separation elements 18 so that the conductive material pieces 70, 72 are in contact with the outer shell 10, 20 walls but not the top or bottom of the outer shells 10, 20. As shown in FIGS. 6 and 7, these conductive material pieces are foils (i.e., having a thickness less than or equal to 1 mm), but the type of material or the thickness thereof is not limited in other embodiments not shown here. As shown in FIG. 6, the first electrode connector 16 and second electrode connector 26 are received by their corresponding electrode connector receptacles 14, 24 from the exterior of the outer shells 10, 20, but are not in contact with the conductive material pieces 70, 72. As shown in FIG. 7, the first electrode connector 16 and second electrode connector 26 are received by their corresponding electrode connector receptacles 14, 24 from the interior of the outer shells 10, 20 and pierce through a portion the conductive material pieces 70, 72 and extend beyond the outer shells 10, 20. Accordingly, a first nut 74 and second nut 76 are used to affix the corresponding electrode connectors 16, 26 to their corresponding outer shells 10, 20. The third electrode connector 66 and/or inner conductive material ring 68 conductive material may be selected from the list consisting of a metal (e.g., copper, iron, aluminum, tin, chromium, titanium, silver, platinum, nickel, magnesium, gold, other suitably conductive metals), an alloy (e.g., stainless steel, carbon steel, brass, bronze, other suitable alloys of the metals above), a semiconductor (e.g., silica, n-doped silica, p-doped silica, graphite, graphene, germanium, gallium arsenide, cadmium telluride, zinc oxide, other commonly semiconductive materials), some other suitable conductive material, or a combination thereof. The embodiments of FIGS. 6 and 7 may be preferred in situations where the anode and/or cathodes include expensive metals so that the total amount needed can be minimized. Accordingly, the embodiments shown in FIGS. 6 and 7 are particularly well suited to utilize foil electrodes comprising platinum, palladium, titanium, or other electrodes that would be impractical to use in the construction of an entire outer shell 10, 20.

Another difference between the mechanoelectrochemical cell 500 and the mechanoelectrochemical cells 600, 700 is the means for connecting the outer shells 10, 20 to the third portion 60 shown in the figures. As shown in FIG. 5, the outer shells 10, 20 of the mechanoelectrochemical cell 500 have reduced external perimeters at the open ends that are configured to partially extend into the third portion 60 and be received by a portion having a corresponding reduced inner perimeter. Once so received, the first portion 10, second portion 20, and third portion 60 are configured to be joined together using a conventional means for connecting materials such as applying an external force (e.g., clamping), adhesives, or any other suitable means for connecting two or more physical components. As shown in FIGS. 6 and 7, the outer shells 10, 20 of the mechanoelectrochemical cells 600, 700 are configured to be joined in a threaded connection between each of the outer shells 10, 20 and the third portion 60. This embodiment is not intended to be limiting, and other suitable means for connecting two or more materials together such as, by way of example and not limitation, applying an external force, using an adhesive, or other suitable means for connecting components may be employed.

With respect to FIGS. 5 and 6, the electrode connectors 16, 26 and the electrode connector receptacles 14, 24 are optional because the first outer shell 10 and the second outer shell 20 are made using conductive materials such as those outlined above. Instead, it is possible to solder on the connections to the power supply in order to have the outer shells 10, 20 act as electrodes in this embodiment. Alternatively, it is possible to connect to the outer shells 10, 20 in other ways that do not interfere with the flow of electrons such as, for example, using an adhesive (e.g., tape), clamping, or other known means of connecting two adjacent materials.

With further respect to the embodiments of FIGS. 5-7, the size and shape of the reaction area 8 in mechanoelectrochemical cells 500, 600, 700 differs substantially. Unlike the mechanoelectrochemical cells 100, 400 described above, wherein the reaction area 8 is defined as the difference between the outer perimeter and height of the first conductive material 12 and the inner perimeter and depth of the second outer shell 20, the reaction area 8 in the mechanoelectrochemical cells 500, 600, 700 are primarily determined by the dimensions and shape of third portion 60. Accordingly, the available volume for the mechanoelectrochemical reaction can be controlled by molding the third portion 60 to have the desired shape and/or volume for the reaction based on the reagents, solvent, or other factors discussed in more detail below.

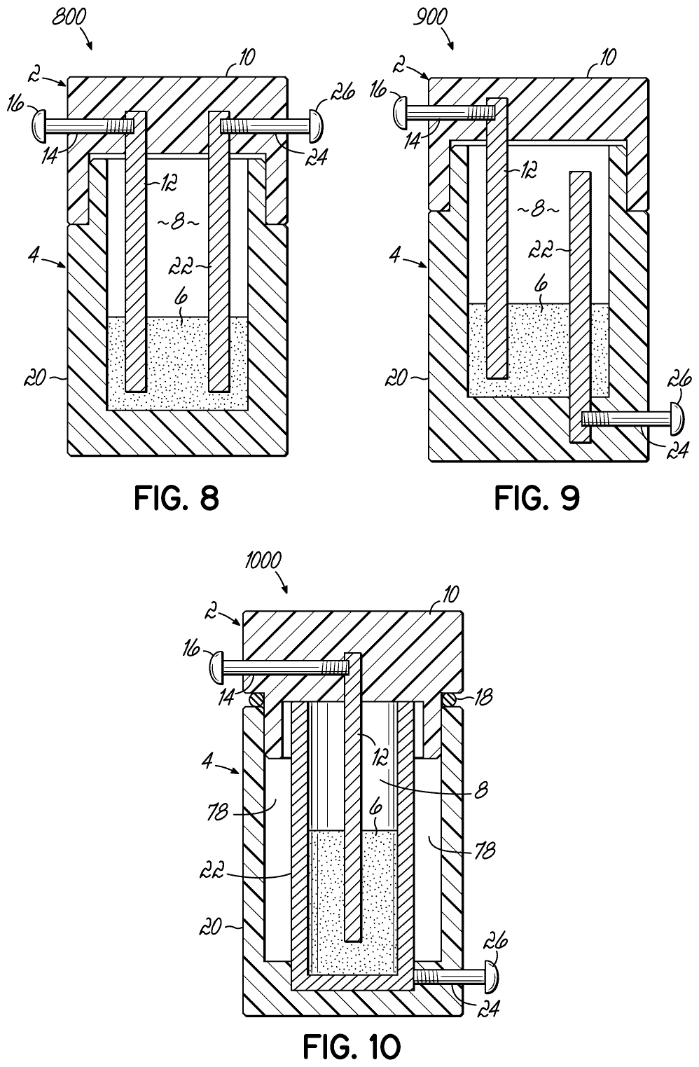

With respect to FIGS. 8 and 9, a further aspect of the invention is shown with mechanoelectrochemical cells 800 and 900. These embodiments are similar to the shape of the mechanoelectrochemical cell 100 shown and described above, but differ several ways. First, the both the first outer shell 10 and the second outer shell 20 are or include an inert material such as those previously disclosed above. Second, the first conductive material 12 and the second conductive material 22 are contained within the inert outer shells 10, 20 and extend therefrom into the reaction area 8. For the mechanoelectrochemical cell 800, both of the conductive materials 12, 22 extend downwardly into the reaction area 8 from the first outer shell 10. An alternate embodiment of the mechanoelectrochemical cell 800 considered would have both conductive materials 12, 22 extending upwardly into the reaction area from the second outer shell 20 (not shown). For the mechanoelectrochemical cell 900, the first conductive material 12 extends downwardly from the first outer shell 10 and the second conductive material extends upwardly from the second outer shell 20.

With respect to FIG. 10, a further aspect of the invention is shown with the mechanoelectrochemical cell 1000. As was the case with the mechanoelectrochemical cell 900 described above, both the first outer shell 10 and the second outer shell 20 are or include an inert material such as those previously identified above. Moreover, both the first conductive material 12 and the second conductive material 22 are contained within the outer shells 10, 20 and extend toward the opposite outer shell 20, 10 respectively. Where this aspect of the invention differs from those above is in the shape of the second conductive material 22. Similar to the mechanoelectrochemical cell 100 wherein the second conductive material 22 was coextensive with the outer shell 20 and defined the reaction area 8, here the second conductive material 22 is configured to define the outer perimeter of the reaction area 8 within the separate outer shell 20 that encloses it. As shown, there is a void space 78 that is defined as the space between the outer perimeter of the second conductive material 22 and the inner perimeter of the outer shell 20. One benefit of enclosing the reaction area 8 within a second conductive material 22 that is itself enclosed within an outer shell 20 is that drawbacks of some previously identified conductive materials that would otherwise be difficult to use as a container due to porosity and/or permeability of the reagent 6 and/or organic liquid carrier can be alleviated. In one such preferred embodiment, the second conductive material 22 is a container formed at least partially from graphite, wherein the graphite second conductive material would otherwise be at least partially permeable to the reagent and/or the organic liquid carrier.

With reference to FIG. 11, an agitating device 1100 containing the mechanoelectrochemical cell 100 is shown in accordance with another aspect of the invention. That the mechanoelectrochemical cell 100 is shown instead of other mechanoelectrochemical cells shown and described herein is solely by way of example and not limitation. The agitating device 1100 is configured to receive the mechanoelectrochemical cell 100 securely and subject the mechanoelectrochemical cell, which contains the reagents 6 (not shown) to physical agitation along arrows 80 that is configured to facilitate or enable a chemical reaction as described more fully below. At the same time, electrodes (not shown) are attached to the first electrode connector 16 and the second electrode connector 26 so that the reagents are simultaneously subjected to an electric current or an electric potential, wherein the electric current or the electric potential is configured to facilitate or enable a chemical reaction as described more fully below.

As shown, the agitating device 1100 may be used to clamp the first portion 2 and the second portion 4 together using a first plate 82 and a second plate 84. The first plate 82 is configured to apply an external force to the first portion 2 in the direction of the second portion 4. The second plate 84 is configured to apply an external force to the second portion 4 in the direction of the first portion 2. The first and second plates 82, 84 are connected by a plurality of rods 86 such that the mechanoelectrochemical cell 100 is securely retained within the agitating device. In other embodiments, such as those where the first portion 2 and the second portion 4 are securely joined using another means of attachment (e.g., a threaded connection), the agitating device 1100 does not need to be configured to function as a clamp as shown here.

The agitating device 1100 shown is a milling device capable of generating high shear forces sufficient to aid or enable mechanochemical reactions. In one embodiment, the agitating device 1100 is a milling device selected from a list consisting of a ball mill, a screw mill, a rotating plate mill, and a mixer mill. In one such embodiment, the agitating device 1100 is a mixer mill. In another embodiment, the agitating device is a ball mill, wherein a plurality of balls are contained within the mechanoelectrochemical cell along with the reagents. Without being bound by theory, it is believed that ball milling may further help reduce the need for solvent by decreasing the available space, thereby ensuring better contact between the reagents and the electrodes. However, this is not intended to be a limiting aspect of the disclosure. Other agitating devices sufficient to enable mechanochemistry without prohibiting the simultaneous application of electric current or electric potential between electrodes may be used. In one embodiment, the agitating device 1100 is configured to agitate the reagents 6 and the solvent without stirring.

With reference now to the methods of using the mechanoelectrochemical cells disclosed herein, various reactions can be implemented. In various embodiments, the mechanoelectrochemical cell ca be utilized to facilitate a redox reaction of the reagents 6, including at least one organic substrate and an organic solvent, such as, by way of example and not limitation, the reduction of benzophenone to diphenylmethanol, the reduction of an aryl bromide, the synthesis of sulfonamides (i.e., oxidation), or other suitable electrochemical redox reactions. For example, when using mechanoelectrochemistry for the syntheses of sulfonamides, it is possible to achieve both similar product yields as measured by conversion percentages while significantly reducing the amount of solvent needed to less than 5 mL, alternatively less than 3 mL, or in a preferred embodiment about 2 mL.

The other significant benefit to mechanoelectrochemical processes is that it can substantially help improve important green chemistry metrics. For example, an important green chemistry metric can be selected from the list consisting of the process mass intensity (PMI), mass efficiency, atom efficiency, life cycle assessment, or other similar metrics used to evaluate how green a chemical process is. With respect to PMI, the benefit of mechanoelectrochemistry may reduce PMI by a percentage of an otherwise equivalent electrochemical process. In one such embodiment, the PMI of the mechanoelectrochemical process is less than or equal to 50%, alternatively less than or equal to 40%, alternatively less than or equal to 30%, alternatively less than or equal to 25%, alternatively less than or equal to 20%, or alternatively less than or equal to 10%. With respect to mass efficiency, the mechanoelectrochemical process can lower the amount of solvent, thereby reducing solvent waste and improving the mass efficiency. In some embodiments, the mass efficiency of the mechanoelectrochemical process is improved relative to the otherwise equivalent electrochemical process by a percentage greater than or equal to 5%, alternatively greater than or equal to 10%, alternatively greater than or equal to 15%, alternatively greater than or equal to 20%, alternatively greater than or equal to 25%, or alternatively greater than or equal to 35%. With respect to atom efficiency, this is reduced where the amount of unwanted byproducts formed is reduced. This is especially important where multiple products can be formed in a single reaction. In such embodiments, mechanoelectrochemical processes may improve the atom efficiency when compared to an otherwise equivalent electrochemical process that is less selective for the desired process. With respect to life cycle assessment, impact of a reaction on the environment in general (e.g., solvent used, energy used, carbon footprint, etc.) is assessed holistically. In one embodiment, life cycle assessment is improved by reducing the solvent used. In another embodiment, life cycle assessment is improved by reducing the energy used. In yet another embodiment, life cycle assessment is improved by reducing the solvent used.

Solvents can be used depending on the reaction that is being performed. Generally speaking, limitations on which solvents can be used, including organic solvents (e.g., acetonitrile, ethanol, acetone, DMS, DMSO, methanol, THF, etc.), water, other solvents, or combinations thereof will depend on the reaction to be performed. In some embodiments, the chosen solvent or solvent mixture is chosen based on the dielectric constant of the solvent mixture. In one embodiment, the solvent or solvent mixture has a dielectric constant that is above a minimum. In one embodiment, the solution has a dielectric greater than or equal to 5, alternatively greater than or equal to 10, alternatively greater than or equal to 20, alternatively greater than or equal to 30 alternatively greater than or equal to 40, alternatively greater than or equal to 50, alternatively greater than or equal to 60, alternatively greater than or equal to 70, or alternatively greater than or equal to 80. In other embodiments, the solvent is chosen to avoid a situation in which the solvent itself undergoes a redox reaction.

In various embodiments, the simultaneous application of mechanochemical milling and electric current or electric potential to the reagents 6 to product a chemical product may result in the improvement of at least one reaction metric relative to an otherwise identical reaction for producing a chemical product only including one of electrochemistry and mechanochemistry. The at least one reaction metric may be increasing product yield, reducing organic solvent consumption, reducing the reaction time, reducing the amount of at least one toxic reagent or solvent, completely eliminating at least one toxic reagent or solvent, and/or enabling electrochemical synthesis of the chemical product without complete solubility of the organic substrate in the organic solvent. In some embodiments, this enables creating a slurry using the reagent 6 and solvent. In some cases, a slurry can be achieved if the ratio of solvent to reagent or organic substrate n is greater than or equal to 1 and less than or equal to 12, alternatively greater than or equal to 3 and less than or equal to 11, or alternatively greater than or equal to 5 and less than or equal to 10. In some particular embodiments, a slurry is achieved when the n value is about 5, alternatively about 6.25, or alternatively about 10. In other cases, this allows for liquid assisted grinding. In one such embodiment, the amount of solvent included results in an n value that is less than or equal to 5, alternatively less than or equal to 3, or alternatively less than or equal to 1.

### Example 1

### Method

In this example, the effects of milling frequency was analyzed to relative to the percent yields of the mechanoelectrochemical reduction of benzophenone to diphenylmethanol. Reagents included 8 mL of a solvent comprising 4:1 v/v acetonitrile:ethanol, 75 mol % tetrabutylammonium hexafluorophosphate (TBAPF6), with 160 mg of benzophenone as a substrate (n=50 μL/mg, i.e., ratio of solvent to substrate) without a mixing ball and at a voltage of −4.5V. The reagents were placed within the mechanoelectrochemical cell 100 having a wall space 30 of about 50% and a floor space 36 of about 10% (herein “MEC 1”) for 1 hour, which in turn was connected to an external power source was securely held by the Spex 8000 mixer mill.

### Results and Discussion

TABLE 1
Demonstrates the correlation between milling
frequency and percent conversion.

| Milling Frequency (Hz) | Percent Conversion (%) |
|---|---|
| 0 | 73 |
| 1 | 88 |
| 4 | 39 |
| 9 | 65 |
| 13 | 43 |
| 17 | 60 |
| 20 | 65 |
| 23 | 63 |

Interestingly, slight agitation at 1 Hz performed best, with no agitation performing 15% worse. While further increasing the milling frequency to 4 and 13 Hz further reduced the reaction conversion, these losses in conversion were minimized at higher frequencies and at 9 Hz. Without being bound by theory, it is believed that excessive agitation can disrupt the electrode-electrolyte interface and hinder the reaction.

### Example 2

### Method

In this example, the effects of solvent to substrate ratio was analyzed to relative to the percent yields of the mechanoelectrochemical reduction of benzophenone to diphenylmethanol at 0 Hz and at 17 Hz and at a voltage of −4.5V. Reagents included a solvent comprising 4:1 v/v acetonitrile:ethanol, 10 mol % TBAPF6, and benzophenone as a substrate at various solvent-substrate ratios η. The reagents were placed within the mechanoelectrochemical cell 100 having the MEC 1 configuration for 2 hours, which in turn was connected to an external power source was securely held by the Spex 8000 mixer mill. Additionally, the orientation of the mechanoelectrochemical cell 100 relative to the ground (horizontal or vertical) was tested.

### Results and Discussion

TABLE 2
Demonstrates the correlation between solvent-
substrate ratio and percent conversion.

| | | Milling Frequency | | |
|---|---|---|---|---|
| Entry | η (μL/mg) | (Hz) | Orientation | Conversion (%) |
| 1 | 0 | 0 | Horizontal | 0 |
| 2 | 0 | 17 | Horizontal | 0 |
| 3 | 1 | 0 | Horizontal | 0 |
| 4 | 1 | 17 | Horizontal | 0 |
| 5 | 12.5 | 0 | Horizontal | 5 |
| 6 | 12.5 | 17 | Horizontal | 0 |
| 7 | 12.5 | 0 | Vertical | 49 |

Testing the mechanoelectrical cell without solution (η=0) and with minimal solution (η=1) unsurprisingly did not result in meaningful reduction of benzophenone. When the solvent was increased to 2 mL (η=12.5), a minimal amount of electrochemical conversion was observed when no mechanical agitation was used, with higher conversion in the vertical orientation. Without being bound by theory, it is believed that the low solvent volumes were insufficient to establish sufficient connection with both electrodes for (η=0 and 1), that agitation reduced yields in the horizontal orientation because increased splashing decreased electrode contact, and the smaller gap between the electrodes in the vertical orientation improved electrode contact and yields.

### Example 3

### Method

In this example, the effects of minimizing solvent to substrate ratio in another version of the reaction chamber (herein “MEC 2”) better suited for a horizontal orientation at various voltages was analyzed to relative to the percent yields of the mechanoelectrochemical reduction of benzophenone to diphenylmethanol at 4 Hz. Reagents included a solvent comprising 3:1 v/v acetonitrile:ethanol, 75 mol % TBAPF6, and benzophenone as a substrate at various solvent-substrate ratios n for 2 hours. The reagents were placed within the mechanoelectrochemical cell 100 having a wall space 30 of about 1% and a floor space 36 of about 99%, which in turn was connected to an external power source was securely held by the Spex 8000 mixer mill.

### Results and Discussion

TABLE 3
Demonstrates the correlation between solvent-substrate
ratio and percent conversion inthe new mechanochemical
cell 100 in a horizontal orientation.

| | | | | Milling | |
|---|---|---|---|---|---|
| Entry | η (μL/mg) | | Voltage (V) | Frequency (Hz) | Conversion (%) |
| 1 | 40 | (Solution) | −6.0 | 4 | 88 |
| 2 | 40 | (Solution) | −6.7 | 4 | 77 |
| 3 | 10 | (Slurry) | −7.0 | 4 | 55 |
| 4 | 10 | (Slurry) | −7.4 | 0 | 43 |
| 5 | 5 | (Slurry) | −8.1 | 4 | 0 |
| 6 | 5 | (Slurry) | −10.0 | 4 | 0 |
| 7 | 5 | (Slurry) | −10.0 | 4 | 0 |

Testing the mechanoelectrical cell with almost solution (n=5, 0.25 mL of solution) did not result in any conversion, even at high voltage, due to difficulties in maintaining a current across the mechanoelectrochemical cell 100 likely arising from issues with electrode contact. In entry 7, a milling ball was added to the system, but minimal solution volume continued to hamper this system. However, this set up did allow for appreciable conversion minimal solution (η=10, 0.5 mL of solution), which increased further when the amount of solution was increased to 1 mL (η=20) and 2 mL (η=40). Notably, when no milling occurred in entry 4, the conversion was reduced by about 12% when compared to an equivalent test except for milling at 4 Hz.

### Example 4

### Method

In this example, the effects of minimizing solvent to substrate ratio in another version of the reaction chamber (herein “MEC 3”) better suited for either a vertical or a horizontal orientation was analyzed to relative to the percent yields of the mechanoelectrochemical reduction of 4-Bromo-benzophenone at 4 Hz for 2 hours. Reagents included 1.5 mL solvent comprising 3:1 v/v acetonitrile:ethanol, 25 mol % TBAPF6, and 4-Bromo-benzophenone as a substrate at η=6.25, resulting in a slurry mixture. The reagents were placed within the mechanoelectrochemical cell 100 “MEC 3” having a wall space 30 of about 10% and a floor space 36 of about 25%, which in turn was connected to an external power source was securely held by the Spex 8000 mixer mill.

### Results and Discussion

TABLE 4
Demonstrates the effects of minimizing solvent-substrate
ratio in the MEC 3 mechanochemical cell 100.

| | | Applied | | | |
|---|---|---|---|---|---|
| | | Current | Milling | Milling | Conversion |
| Entry | η (μL/mg) | (mA) | Frequency (Hz) | Ball (#) | (%) |
| 1 | 6.25 (Slurry) | — | 4 | 2 | 0 |
| 2 | 6.25 (Slurry) | −100 | 0 | 2 | 4 |
| 3 | 6.25 (Slurry) | −100 | 4 | 2 | 64 |
| 4 | 6.25 (Slurry) | −100 | 4 | 0 | 65 |

First, the cell was tested with mechanochemical milling but without applying current, achieving no conversion, demonstrating the electrochemical nature of the reaction. Second, the cell was tested without mechanochemical milling but with applied current, achieving 4% conversion. Third, the cell was tested with both mechanochemical milling and applied current, achieving 64% conversion, demonstrating the symbiotic effect of simultaneous mechanoelectrochemical processes, especially under solvent minimized conditions. Finally, the fourth entry tested the same conditions as the third test but without the milling ball, achieving roughly equivalent conversion of 65%. These conversion percentages included a distribution of products, including benzophenone (about 51%), benzohydrol (diphenylmethanol) (about 12%), and 4-bromo-benzohydrol (about 2%).

Collectively, this demonstrates that the mechanochemical cell 100 taught herein can function without the milling ball, but it may still be included. The crucial role of mechanochemistry in enhancing mixing and facilitating the transformation in slurry-based systems underscores the need for a combined mechanochemical and electrochemical approach. These findings confirm the critical importance of coupling mechanochemistry with electrochemistry to ensure successful reaction progression. The absence of either element significantly hinders product formation.

### Example 5

### Method

In this example, the effects of changing the milling frequency while minimizing solvent to substrate ratio in MEC 3 was analyzed to relative to the percent yields of the mechanoelectrochemical reduction products of 4-Bromo-benzophenone at 4 Hz for 2 hours. These reduction percentages included a distribution of products, including benzophenone (Product 1), benzohydrol (diphenylmethanol) (Product 2), and 4-bromo-benzohydrol (Product 3). Reagents included 1.5 mL solvent comprising 3:1 v/v acetonitrile:water, 25 mol % TBAPF6, and 4-Bromo-benzophenone as a substrate at η=6.25, resulting in a slurry mixture. Accordingly, except for changing the acetonitrile used in the previous example for water, the reagents are equivalent. The reagents were placed within the mechanoelectrochemical cell 100 “MEC 3”, which in turn was connected to an external power source was securely held by the Spex 8000 mixer mill.

### Results and Discussion

TABLE 5
Demonstrates the effects of changing the milling
frequency while minimizing solvent-substrate
ratio in the MEC 3 mechanochemical cell 100.

| Product | 0 Hz | 4 Hz | 9 Hz | 17 Hz |
|---|---|---|---|---|
| 1 | 4% | 51% | 21% | 16% |
| 2 | 0% | 12% | 1% | 0% |
| 3 | 0% | 2% | 4% | 12% |

When tested without mechanical milling, a small amount of product 1 was formed. When the mechanical milling was increased to 4 Hz, similar results were obtained when compared to the same process carried out in Example 4. When the frequency was further increased, overall conversion was reduced at 9 Hz (26%) and at 17 Hz (28%). Interestingly, the composition of the products formed changed significantly, reducing the amount of products 1 and 2 while increasing the amount of product 3. This demonstrates that while increased frequency tends to lower yields, it may be preferable to increase frequency depending on the desired product to be formed.

### Example 6

### Method

In this example, the effects of mechanoelectrochemical synthesis on various brominated aromatic compounds were tested while minimizing solvent to substrate ratio at 4 Hz for 2 hours. The brominated aromatic compounds tested to mechanoelectrochemically remove one of the bromine group included 4-Bromo-benzophenone (Reactant 1), 4-bromo-benzonitrile (Reactant 2), 4-bromo-acetophenone (Reactant 3), 4-bromo-methylbenzoate (Reactant 4), 1,3,5-tribromobenzene (Reactant 5), and 9-bromo-anthracene (Reactant 6). Reagents included 1.5 mL solvent comprising 3:1 v/v acetonitrile:water, 25 mol % TBAPF6, and 4-Bromo-benzophenone as a substrate at η=6.25, resulting in a slurry mixture. The reagents were placed within the mechanoelectrochemical cell 100 “MEC 3”, which in turn was connected to an external power source was securely held by the Spex 8000 mixer mill.

### Results and Discussion

TABLE 6
Demonstrates the capabilities of mechanoelectrochemical reactions
for de-brominating various aromatic compounds while minimizing
solvent-substrate ratio in the MEC 3 mechanochemical cell 100.

| | | Applied | | |
|---|---|---|---|---|
| | | Current | Milling | Conversion |
| Reactant | η (μL/mg) | (mA) | Frequency (Hz) | (%) |
| 1 | 6.25 (Slurry) | −100 | 4 | 49 |
| 2 | 6.25 (Slurry) | −100 | 4 | 73 |
| 3 | 6.25 (Slurry) | −100 | 4 | 61 |
| 4 | 6.25 (Slurry) | −100 | 4 | 36 |
| 5 | 6.25 (Slurry) | −100 | 4 | 9 |
| 6 | 6.25 (Slurry) | −100 | 4 | 0 |

For reactants 1 through 4, the mechanoelectrochemical cell was able to reduce the reagents with a significant yield. For Reactants 5 and 6, these yields were low or non-existent respectively. Without being bound by theory, it is believed that this may be caused by higher reduction potentials, lower rates of electron transfer at the electrode surface due to their reduced solubility, or a combination thereof. In either case, this example clearly demonstrates the viability of the mechanoelectrochemical cell 100 demonstrated herein for a wide range of redox reactions.

Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

1. A method of synthesizing a chemical product from a substrate and a solvent using a redox reaction, the method comprising:
(a) applying mechanochemical activation to the substrate and the solvent, wherein mechanochemical activation does not involve stirring; and
(b) simultaneously applying an electric current or an electric potential in an amount sufficient to simultaneously induce an electrochemically mediated reaction of the substrate.

2. The method of claim 1, wherein the simultaneous application of the electric current or the electric potential and mechanochemical activation improves at least one reaction metric, relative to an otherwise identical reaction not including either step (a) or step (b), selected from the list consisting of:
increasing product yield;
reducing solvent consumption;
reducing the reaction time;
reducing the amount of at least one toxic reagent or solvent;
completely eliminating at least one toxic reagent or solvent; and
enabling electrochemical synthesis of the chemical product without complete solubility of the substrate in the solvent.

3. The method of claim 2, wherein the improved reaction metric comprises improving product yield, and wherein improved product yield is measured as an increase in the percent conversion of the organic substrate into the chemical product.

4. The method of claim 2, wherein the improved reaction metric comprises reducing solvent consumption as measured by a reduction in process mass intensity (PMI) relative to at least one of an otherwise equivalent electrochemical cell batch process and an otherwise equivalent microflow electro-cell process.

5. The method of claim 2, wherein the improved reaction metric comprises a reduced reaction time.

6. The method of claim 2, wherein the improved reaction metric comprises reducing the amount of at least one toxic reagent or solvent.

7. The method of claim 2, wherein the improved reaction metric comprises eliminating at least one toxic reagent or solvent.

8. The method of claim 2, wherein the improved reaction metric comprises enabling electrochemical synthesis of the chemical product without complete solubility of the substrate in the solvent.

9. The method of claim 1, wherein the mechanochemical agitation comprises mechanochemical milling.

10. The method of claim 9, wherein the mechanochemical milling comprises either mixer milling or ball milling.

11. The method of claim 1, wherein the redox reaction occurs within a reaction area having a volume, wherein the solvent is included at a volume that is less than or equal to 40% of the reaction area volume, and wherein the mechanochemical agitation improves contact of the substrate with a plurality of electrodes used to apply the electric current or the electric potential.

12. The method of claim 1, wherein the mechanochemical agitation occurs at a frequency at or below 30 Hz.

13. The method of claim 1, wherein the ratio of the solvent to the substrate is less than or equal to 50 μL/mg.

14. The method of claim 1, wherein the ratio of the solvent to the substrate is less than or equal to 12.5 μL/mg.

15. A mechanoelectrochemical cell configured to simultaneously subject at least one reagent substrate to simultaneous mechanochemical and electrochemical reactions, the or mechanoelectrochemical cell comprising:
a first portion comprising:
a first outer shell comprising an electrically inert material;
a first electrode positioned within the first outer shell; and
a second portion comprising:
a second outer shell, wherein the second outer shell is configured to function as a second electrode;
wherein the first portion and the second portion are connected to form a sealed reaction area between the first electrode and second electrode.

16. The mechanoelectrochemical cell of claim 15, wherein the second portion comprises a modular portion configured to receive a modular component selected from the list consisting of a vent, a third electrode, and a window.

17. The mechanoelectrochemical cell of claim 16, wherein the second portion further comprises a vent.

18. A mechanoelectrochemical cell configured to simultaneously subject at least one reagent to simultaneous mechanochemical and electrochemical reactions, the mechanoelectrochemical cell comprising:
a first portion comprising:
a first outer shell; and
a first electrode;
a second portion comprising:
a second outer shell; and
a second electrode; and
a third portion, wherein the third portion is configured to connect with the first outer shell on a first end and the second outer shell on a second end to form a sealed reaction area, and wherein the points of connection between the third portion and both the first portion and the second portion remain electrically insulated.

19. The mechanoelectrochemical cell of claim 18, wherein the first outer shell functions as the first electrode, and wherein the second outer shell functions as the second electrode.

20. The mechanoelectrochemical cell of claim 18, wherein the first electrode is a first conductive piece positioned at a distal end of the first outer shell, and wherein the second electrode is a second conductive piece positioned at a distal end of the second outer shell.
